(19) United States
(12) Patent Application Publication
(10) Pub. No.: US 2012/0174107 A1
(43) Pub. Date: Jul. 5, 2012

(54) ELECTRONIC DEVICE AND CONTROL METHOD FOR RUNNING APPLICATION

(75) Inventor: XIN GUO, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/211,333

(22) Filed: Aug. 17, 2011

(30) Foreign Application Priority Data
Dec. 31, 2010 (CN) 201010616784.2

(51) Int. Cl. G06F 9/46; G06F 1/00

(52) U.S. Cl. 718/100

(57) ABSTRACT

An electronic device capable of selecting an appropriate running mode for a to-be-run application is provided. The device is powered by a battery and runs a number of applications, which can be run in different running modes. The device includes a storage unit and a processor. The storage unit stores a relationship among the number of applications, running modes, and power consumption speeds. The processor detects current battery capacity of the battery, obtains the power consumption speeds corresponding to a to-be-run application being run in different modes respectively, and determines running times of the application in the different modes. The processor further compares each determined running time with a preset running time of the application and controls the application to be run in one mode according to the comparison result. A related control method is also provided.

### BACKGROUND

1. Technical Field

The present disclosure relates to electronic devices and, particularly, to an electronic device capable of selecting an appropriate running mode for a to-be-run application installed in the electronic device and a control method for running the application.

2. Description of Related Art

When not being connected to a main power source, portable electronic devices, such as notebooks computers, are usually powered by an internal rechargeable battery. However, if the battery capacity of the rechargeable battery is relatively low, the portable electronic devices may power off abruptly, which may cause some operations to be interrupted. Therefore, it is desirable to provide a portable electronic device to solve above shortcomings.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device in accordance with an exemplary embodiment.

FIG. 2 is a flowchart of a control method for running applications installed in the electronic device of FIG. 1, in accordance with an exemplary embodiment.

### DETAILED DESCRIPTION

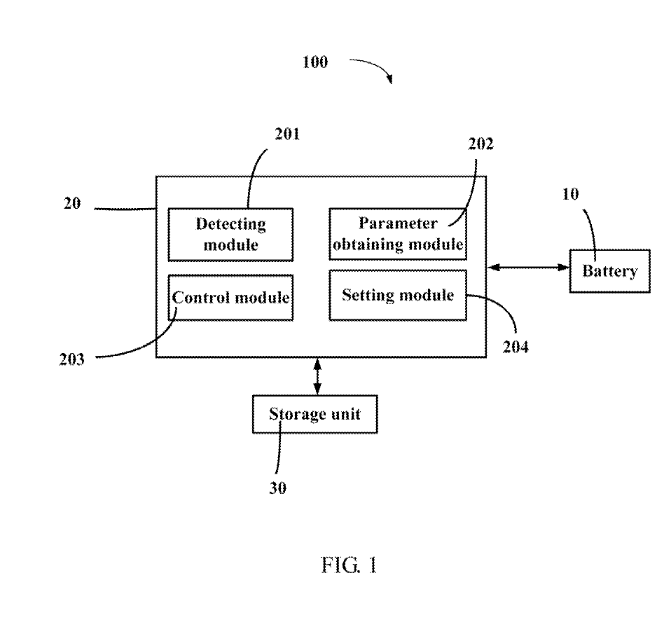

Referring to FIG. 1, an electronic device 100 includes a battery 10 to supply power to the electronic device 100. A number of applications are installed in the electronic device 100. Each application can be run in at least two running modes and each running mode corresponds to one power consumption speed. The electronic device 100 can determine each to-be-run application in an appropriate running mode according to current battery capacity of the battery 10, to cause the application to be run for a period preset by a user. The electronic device 100 may be a notebook, an MP3, an MP4, or a DVD player.

The electronic device 100 includes a processor 20 and a storage unit 30. The storage unit 30 stores a relationship among the number of applications, at least two running modes corresponding to each application, and the power consumption speed corresponding to each running mode of each application. In this embodiment, each application installed in the electronic device 100 can be run in three different running modes, a high performance mode, a normal performance mode, and a low performance mode. The relationship may be recorded in a table (shown below) stored in the storage unit 30.

| | | POWER |
|---|---|---|
| | | CONSUMPTION |
| APPLICATION | RUNNING MODES | SPEEDS |
| APPLICATION A | HIGH PERFORMANCE MODE | SPEED V1.1 |
| | NORMAL PERFORMANCE | SPEED V1.2 |
| | MODE | |
| | LOW PERFORMANCE MODE | SPEED V1.3 |
| APPLICATION B | HIGH PERFORMANCE | SPEED V2.1 |
| | MODE | |
| | NORMAL PERFORMANCE | SPEED V2.2 |
| | MODE | |
| | LOW PERFORMANCE MODE | SPEED V2.3 |
| . . . | . . . | . . . |

The power consumption speed V1 corresponding to the high performance mode of one application is greater than the power consumption speed V2 corresponding to the normal performance mode of the application, and the power consumption speed V2 is greater than the power consumption speed V3 corresponding to the low performance mode of the application. Thus, using the same battery capacity of the battery 10, a first running time T1 capable of running the application in the high performance is less than a second running time T2 capable of running the application in the normal performance, and the second running time T2 is less than a third running time T3 capable of running the application in the low performance. For example, in this embodiment, if high definition and sound quality of a game is desired, the game application needs to be run in a high performance mode, thus a graphics card and a sound card of the notebook 100 must work in the high performance, which results in a higher power consumption speed. If high definition and sound quality is not desired, the game application may be run in a normal or low performance mode, thus the graphics card and the sound card of the notebook 100 may work in a normal or low performance, which results in a lower power consumption speed.

The processor 20 includes a detecting module 201, a parameter obtaining module 202, and a control module 203. The detecting module 201 detects current battery capacity of the battery 10. The parameter obtaining module 202 obtains the power consumption speeds corresponding to one to-be-run application. The control module 203 determines different running times of the to-be-run application in the at least two running modes, according to the power consumption speeds corresponding to the application being run in the different modes respectively and the detected battery capacity of the battery 10. The control module 203 further compares each of the determined running times with a preset running time T corresponding to the application, and controls the application to be run in one running mode according to the comparison result. In this embodiment, the detecting module 201 further detects different power consumption speeds of a newly installed application run in the at least two different running modes, and stores the relationship among the newly installed application, the at least two different running modes, and the detected power consumption speeds in the storage unit 30.

In this embodiment, the processor 20 further includes a setting module 204 to provide a user interface on a display (not shown) of the electronic device 100 for users to input a preset running time T of one to-be-run application. The setting module 204 further generates a prompt to prompt users to re-enter the preset running time T if the input preset running time T is greater than the third running time T3 corresponding to the application, and stores the input preset running time T in the storage unit 30 if the input preset running time T is less than or equal to the third running time T3 corresponding to the to-be-run application. In this embodiment, the setting module 204 displays the third running time T3 corresponding to the application if the input preset running time T is greater than the third running time T3, indicating the longest time the application can be run. For example, when a game application is to be run, the user may input a preset running time T, such as 30 minutes and the third running time T3 corresponding to the application is now 20 minutes, which is less than 30 minutes, thus the setting module 204 displays the longest preset time 20 minutes to prompt the user to re-enter the preset running time T. In an alternative embodiment, the setting module 204 may first display the third running time T3 on the user interface to indicate the longest time the application can be run, thus the user can input a running time according to the third running time T3.

In this embodiment, the control module 203 determines a first run time T1, a second run time T2, and a third run time T3 of the to-be-run application. The control module 203 controls the application to be run in the high performance mode if the preset running time T corresponding to the application is less than or equal to the first running time T1 corresponding to the application, controls the application to be run in the normal performance mode if the preset running time T is greater than the first running time T1 but less than or equal to the second running time T2 corresponding to the application, and controls the application to be run in the low performance mode if the preset running time T is greater than the second running time T2 but less than or equal to the third running time T3 corresponding to the to-be-run application.

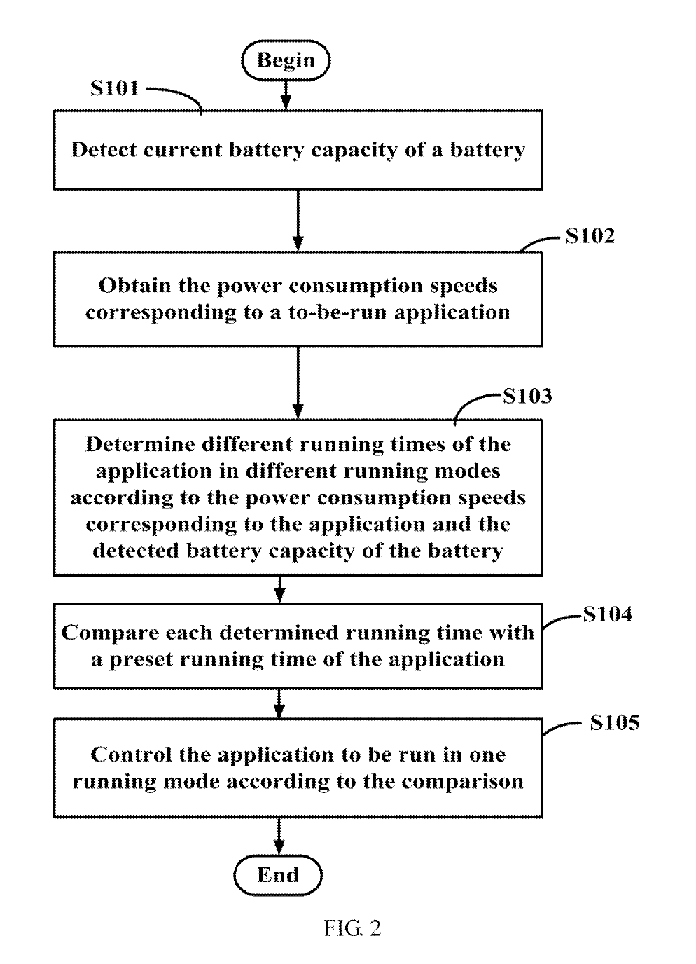

Referring to FIG. 2, a flowchart of a control method for running applications installed in the electronic device 100 is shown.

In step S101, the detecting module 201 detects the current battery capacity of the battery 10.

In step S102, the parameter obtaining module 202 obtains the power consumption speeds corresponding to a to-be-run application.

In step S103, the control module 203 determines running times of the application in the at least two running modes respectively according to the power consumption speeds corresponding to the to-be-run application being run in the different modes respectively and the detected battery capacity of the battery 10.

In step S104, the control module 203 further compares each of the determined running times with a preset running time T of the application.

In step S105, the control module 203 further controls the application to be run in one of the running modes according to the comparison.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device for being powered by a battery and running a plurality of applications, comprising:
a storage unit to store a relationship among the plurality of applications, running modes, and power consumption speeds, each application being capable of being run in at least two running modes, each running mode of each application corresponding to one power consumption speed, the storage unit further to store a plurality of modules; and
a processor to execute the plurality of modules, wherein the plurality of modules comprise instructions executable by the processor to:
detect current battery capacity of the battery;
obtain the power consumption speeds corresponding to a to-be-run application of the plurality of applications;
determine running times of the to-be-run application in the at least two running modes according to the power consumption speeds corresponding to the to-be-run application being run in the at least two running modes respectively and the detected battery capacity of the battery;
compare each of the determined running times with a preset running time of the to-be-run application to generate a comparison result; and
control the to-be-run application to be run in one of the at least two running modes according to the comparison result.

2. The electronic device as described in claim 1, wherein the plurality of modules further comprises instructions executable by the processor to provide a user interface for users to input the preset running time of the to-be-run application.

3. The electronic device as described in claim 2, wherein the at least two running modes of each of the plurality of applications comprise a high performance mode, a normal performance mode, and a low performance mode.

4. The electronic device as described in claim 3, wherein the power consumption speed corresponding to the high performance mode of one application is greater than that corresponding to the normal performance mode of the application, and the power consumption speed corresponding to the normal performance mode of the application is greater than that corresponding to the low performance mode of the application, a first running time corresponding to the high performance mode of the application is less than a second running time corresponding to the normal performance mode of the application, and the second running time corresponding to the normal performance mode of the application is less than a third running time corresponding to the low performance mode of the application.

5. The electronic device as described in claim 4, wherein the plurality of modules further comprise instructions executable by the processor to generate a prompt to prompt the user to re-enter the preset running time if the input preset running time is greater than the third time corresponding to the application, and store the input preset running time in the storage unit if the input preset running time is less than or equal to the third running time corresponding to the to-be-run application.

6. The electronic device as described in claim 5, wherein the third running time corresponding to the application is displayed on the user interface if the input preset time is greater than the third running time corresponding to the to-be-run application.

7. The electronic device as described in claim 4, wherein the plurality of modules further comprise instructions executable by the processor to control the to-be-run application to be run in the high performance mode if the preset running time of the to-be-run application is less than or equal to the first running time corresponding to the to-be-run application, control the to-be-run application to be run in the normal performance mode if the preset running time is greater than the first running time but less than or equal to the second running time corresponding to the to-be-run application, and control the to-be-run application to be run in the low performance mode if the preset running time is greater than the second running time but less than or equal to the third running time corresponding to the to-be-run application.

8. The electronic device as described in claim 2, wherein the plurality of modules further comprise instructions executable by the processor to detect different power consumption speeds of a newly installed application run in the at least two different running modes, and store the relationship among the newly installed application, the at least two different running modes, and the detected power consumption speeds in the storage unit.

9. A control method for running applications applied in an electronic device, the electronic device being powered by a battery and running a plurality of applications, the electronic device comprising a storage unit to store a relationship among the plurality of applications, running modes, and power consumption speeds, each application being capable of being run in at least two running modes, each running mode of each application corresponding to one power consumption speed, the control method comprising:
detecting current battery capacity of the battery;
obtaining the power consumption speeds corresponding to a to-be-run application of the plurality of applications;
determining running times of the to-be-run application in the at least two running modes respectively according to the power consumption speeds corresponding to the to-be-run application being run in the at least two running modes respectively and the detected battery capacity of the battery;
comparing each of the determined running times with a preset running time of the to-be-run application to generate a comparison result; and
controlling the to-be-run application to be run in one of the at least running modes according to the comparison result.

10. The control method for running application as described in claim 9, wherein a user interface to input the preset running time of the to-be-run application is provided to users.

11. The control method for running application as described in claim 10, wherein the at least two running modes of each application comprises a high performance mode, a normal performance mode, and a low performance mode.

12. The control method for running application as described in claim 11, wherein the power consumption speed corresponding to the high performance mode of each application is greater than that corresponding to the normal performance mode of the application, the power consumption speed corresponding to the normal performance mode of the application is greater than that corresponding to the low performance mode of the application, a first running time corresponding to the high performance mode of the application is less than a second running time corresponding to the normal performance mode of the application, the second running time corresponding to the normal performance mode of the application is less than a third running time corresponding to the low performance mode of the application.

13. The control method for running application as described in claim 12, wherein the control method comprises controlling the to-be-run application to be run in the high performance mode if the preset running time of the to-be-run application is less than or equal to the first running time corresponding to the to-be-run application, controlling the to-be-run application to be run in the normal performance mode if the preset running time is greater than the first running time but less than or equal to the second running time corresponding to the to-be-run application, and controlling the to-be-run application to be run in the low performance mode if the preset running time is greater than the second running time but less than or equal to the third running time corresponding to the to-be-run application.
